(19) United States
(12) Patent Application Publication
(10) Pub. No.: US 2003/0009598 A1
(43) Pub. Date: Jan. 9, 2003

(54) Method for designing demand-sensitive rings

(76) Inventors: Oktay Necip Gunluk, New York, NY (US); John Klincewicz, Wayside, NJ (US); Beth Munson, Little Silver, NJ (US)

Correspondence Address: Henry T. Brendzel, P.O. Box 574, Springfield, NJ, 07081, US

(21) Appl. No.: 09/833,322

(22) Filed: Apr. 12, 2001

(51) Int. Cl. G06F 15/16

(52) U.S. Cl. 709/251

(57) ABSTRACT

A method for provisioning a ring-based network is based on a routing of demands on shortest paths, according to a routing metric, and then assigning the routed demands to a collection of rings provisioned from a set of rings that meets preselected criteria, such as having less than a given number of nodes, and a mileage measure that is less than a given mileage upper threshold. The rings are provisioned to minimize a cost function that accounts for the cost of covering demands in rings, and the cost of failing to cover demands in rings. Further, an ordering of the traffic demands is determined that allows for routing as many traffic demands as possible.

### BACKGROUND OF THE INVENTION

This invention relates to rings formed within a network comprising nodes that are interconnected by links. More particularly, this invention relates to a method for identifying feasible rings within an existing network and for routing traffic through a subset of the identified rings that is selected to reduce a cost measure.

Networks, such as telecommunication networks, comprise nodes and physical links that interconnect the nodes. A node, in the context of this disclosure, is an information routing element, such as a switch. Also in the context of this disclosure, a physical link that connects two nodes corresponds to the actual transmission media, such as cables, that carry information between the two nodes. In some situations there is a physical link between node A and node B, and another physical link between node B and node C, and the two links are permanently connected to each other at node B. In such a case, it is said that there is a logical link between nodes A and C.

Currently, the non-wireless information transmission medium with the greatest capacity to carry information is the optical fiber. Fibers exist that can carry information across a significant bandwidth of light (i.e., colors of light), and this bandwidth can be divided into separate and distinct channels, much like commercial radio broadcast bands. Considering that a fiber connection between two nodes may have 100 fibers or more contained in one or more cables, it is immediately apparent that various failures can occur, such as a cut cable, that would have extremely deleterious effects on the network, since a loss of several terabits/sec of information would occur. Thus, it is highly desirable that fiber networks be survivable.

A network is referred to as survivable if it provides some capability to restore existing connections when a failure occurs in a network component that participates in the connection. The network component can be an optical or electronic component in a node (affecting, perhaps, as little as one information channel), a fiber in a cable, an entire cable, a physical link, or an entire switching node. Design of a survivable network is obtained by exploiting protection and restoration techniques that are able to guarantee an acceptable level of network resilience from failures. Protection techniques typically involve backup paths and wavelengths that are reserved in advance, which can be shared or dedicated.

Architecturally, some of the current networks realize the protection function through a bi-directional ring structure. A ring consists of a set of nodes that form a cycle. Consecutive nodes in the cycle are interconnected by a designated pair of bi-directional information channels (on logical links). One information channel in each ring provides the service” capacity and the other information channel provides the “protection” capacity. The set of logical links that interconnect nodes on a given ring advantageously should be physically disjoint. That is, no two logical links should utilize the same physical link.

At any given time, many different rings may be provisioned in the network. In the architecture considered by this disclosure, if a given information channel is designated to be part of the service capacity of a ring, then this information channel can be used to route traffic.

Each information channel on a logical link in the network has some routing metric (i.e., a “cost” or “length” or “weight”) associated with it that is used only for routing purposes. This routing metric would typically be set by the network administrator. In the architecture assumed by this disclosure, routing is performed automatically by the information routing elements within the nodes, based on the current state of the network. When a demand for a communications connection between a given pair of nodes A and B is presented to the information routing elements within the nodes, they find a sequence of available information channels that form a path between A and B. In particular, the information routing elements choose a “shortest path” of currently “available” information channels, where the shortest path is computed according to the routing metric. The “available” information channels consist of those information channels that do not have demands routed on them already, and that have been provisioned to be part of the service capacity of some ring.

Note that the information channels in a given shortest path need not all be part of the same ring. Note also that the order in which demands are routed by the information routing elements may affect the routes chosen. That is, a demand that is routed early in the ordering of demands may utilize the last available information channel on a given logical link and, consequently, a demand later in the ordering that might have chosen to use that logical link (had information channels been available) has to be routed on a different path.

Examples of commercially-available information routing elements that can be used to route information channels (wavelengths) within an optical fiber network include: Aurora Optical Switches by Tellium, Multiwave Core Director by Ciena, the Metropolis MSX family of products by Lucent, Optera Px by Nortel, and the CorWave Optical Switch by Corvis.

There have been a number of publications that describe methods for choosing a set of rings to serve a given set of demands in a telecommunication network.

A paper by H Luss et al titled “Topological Network Design for SONET Ring Architecture,” IEEE Transactions on Systems, Man and Cybernetics—Part A, vol. 28, pp. 780-790, 1998, describes a heuristic approach for designing networks comprised of interconnected rings. However, it does not consider point-to-point demands. Rather, it seeks only to choose a minimal set of rings such that every node of the network is contained in at least one ring. Furthermore, in generating a set of candidate rings, it considers only a heuristically-generated subset, rather than all feasible rings.

A paper by Fumagalli et al titled “Survivable Networks Based on Optimal Routing and WDM Self-Healing Rings,” Proceedings of IEEE INFOCOM '99, Mar. 21-25, 1999, describes an ILP (Integer Linear Programming) formulation of the problem of minimizing the total wavelength mileage required to support a set of given traffic demands in a given network topology employing self-healing rings. However, like the Luss et al method, this method heuristically generates only a subset of the possible candidate rings. The linear programming model that is then used assumes that demand can be routed arbitrarily. Fumagalli et al also describe a related linear programming model that bypasses the candidate ring generation function and allows all rings to be implicitly considered by the linear programming (LP) solver. However, the extremely large size of the resulting LP makes the approach only applicable to networks that are much smaller than 20 nodes.

Another paper by Fumagalli et al, “Fast Optimization of Survivable WDM Mesh Networks Based on Multiple Self-Healing Rings,” SPIE Conference on All-optical Networking 1999: Architecture, Control and Management Issues, Boston, Mass, September 1999, SPIE Volume 3843, presents a fast approach to interactively designing optimal resilient WDM mesh networks. However, it does not describe how to generate rings. Rather, it assumes that some set of feasible rings is given as input. A final set of rings is then chosen by a simulated annealing heuristic, in which rings are randomly added or subtracted from a tentative solution set. For each modified solution set, traffic is routed and the cost of the solution is computed. Such a simulated annealing approach would take prohibitively long if all feasible candidate rings were considered, or if the network were particularly large.

Slevinsky et al, in “An Algorithm for Survivable Network Design Employing Multiple Self-Healing Rings,” IEEE, 1993, describe an algorithmic approach to synthesis of restorable networks that employ self-healing rings. The described algorithm generates all candidate rings, and the traffic demands are statically routed a priori. The set of rings to cover this a priori routing is then chosen by a greedy heuristic. The method results in a near optimal solution from a capacity efficiency perspective. There is no interaction between the capacity chosen and the selected routing, and no iterative steps are employed to arrive at the solution. A similar method is described by Grover et al in “Optimized Design of Ring-Based Survivable Networks,” Canadian Journal of Electrical and Computer Engineering, vol. 20, pp. 138-149 (1995).

White et al, in “Generic Algorithms and Network Ring Design,” Annals of Operations Research, vol. 86, pp. 347-371, 1999, present an approach in which a genetic algorithm representation encapsulates all aspects of the ring design problem (routing, link capacity determination, and ring design) and solves them simultaneously. However, it assumes that traffic can be routed arbitrarily, rather than following the least-cost available path.

Lastly, a talk titled “LP Models for Covering Demands with Rings,” presented by B. Munson at the Fifth INFORMS Telecommunications Conference, Boca Raton, Fla., Mar. 5-8, 2000, presents an LP model to determine a set of rings that are required to serve a set of demands. However, this model considers a ring-planning environment with no capacity constraints, and in which demand is statically routed a priori, as opposed to following the least-cost available path.

### SUMMARY

An advance in the art is realized with a method for provisioning a ring-based network that is based on minimizing a cost function. In a given network, a set of feasible rings is identified. Assuming an architecture in which demands are routed on a shortest path according to a routing metric, the method then determines which rings, out of this set of feasible rings, should be provisioned. This is done with an eye toward routing as many traffic demands as possible, while minimizing the cost of the provisioned rings. Further, an ordering of the traffic demands is determined that allows for routing as many traffic demands as possible on the provisioned rings.

### BRIEF DESCRIPTION OF THE DRAWINGS

FIG. 1 illustrates a network that can be arranged to comprise self-healing rings;

FIG. 2 presents a block diagram of a node within the FIG. 1 network;

FIG. 3 presents a flowchart of a ring design process that is based on traffic demand; and

FIG. 4 is a detailed flowchart of a module called EXPLORE (PATH, M_BUGT, H_BUGT) that is used within step 102 in the process described in FIG. 3.

### DETAILED DESCRIPTION

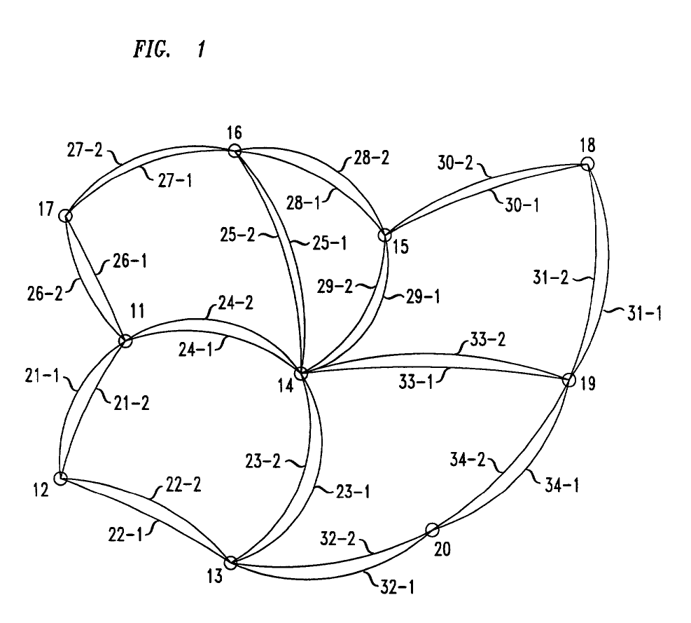

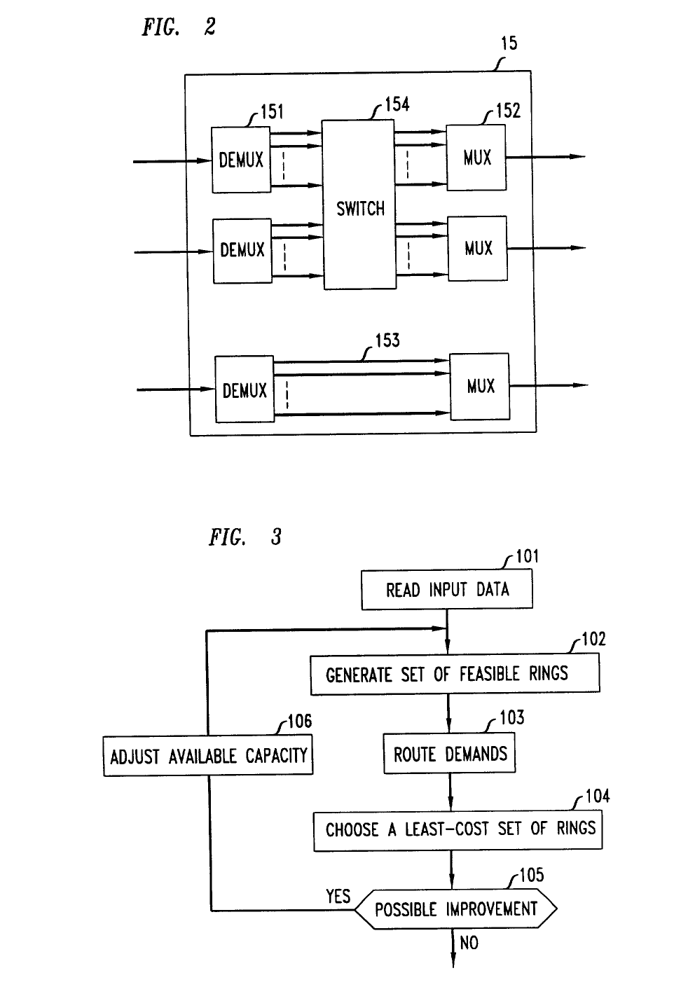

FIG. 1 depicts a network with nodes 11 through 20 that are interconnected by logical link pairs, such as link pair 21-1 and 21-2, while FIG. 2 shows an illustrative node 15 of the FIG. 1 network in greater detail. Illustratively, this node has three incoming physical links and three physical outgoing links. Within the switch, each of the incoming physical links is applied to a demultiplexer, such as element 151, to yield individual channels of information that are connected to a switch. The state of the switch dictates the routing of the information to output ports of the switch, where the information channels are combined within multiplexers, such as element 152, and applied to the outgoing physical links. A node might have not all of the information channels applied to the switch but, rather, have them applied directly (and permanently) to a multiplexer, such as information channel 153 in FIG. 2. Such information channels compose a logical link between links other than node 15; node 15 merely serves as a convenient splicing point for two sections of a single logical link. For example, logical links 25-1 and 25-2 that connect nodes 14 and 16 might result from fibers in the physical links pair 29-1,2 and 28-1,2 that are “spliced” within node 15.

The ability to provision the state of the switches within the nodes of the FIG. 1 network allows traffic to be routed in whatever manner is desired. However, as discussed above, a ring connection arrangement enhances survivability of the network in the face of failures.

A ring consists of a set of nodes that form a cycle. Consecutive nodes in the cycle are connected by a pair of information channels on a logical link. One channel in each pair (say, the channel in the counterclockwise direction) is considered the service channel, while the other channel (say, the channel in the clockwise direction) is considered the protection channel. A ring is provisioned by programming the information routing elements within the nodes in the cycle, so that these information routing elements will associate these particular information channels with each other. Then, when a failure (say, a fiber cut) occurs, the information routing elements are able to re-route traffic that was on the service channels, using the protection channels in the opposite direction around the ring. For example, a ring may be formed that encompasses nodes 11, 14, 16 and 17. For traffic in the counterclockwise direction in such a ring, traffic flows from node 11 to node 14 via an information channel in logical link 24-2, from node 14 to node 16 via an information channel in logical link 25-1, from node 16 to node 17 via an information channel in logical link 27-1, and from node 17 to node 11 via an information channel in logical link 26-1. In the clockwise (protection) direction, traffic flows from node 11 to node 17 via an information channel in logical link 26-2, from node 17 to node 16 via an information channel in logical link 27-2, from node 16 to node 14 via an information channel in logical link 25-2, and from node 14 to node 11 via an information channel in logical link 24-1. When a failure occurs, for example when the fiber cable containing logical links 25-1 and 25-2 is cut, traffic from node 14 to node 16 is routed clockwise via logical link 24-1, then 26-2, and lastly 27-2.

Topographically, the FIG. 1 network can be easily mapped to a large number of different rings that, collectively, include all of the logical links and all of the nodes. Since many information channels are contained on any given logical link, there may be many different rings provisioned in the network that consist of the same set of nodes, interconnected by the same logical links, but utilizing different information channels. Such a set of rings is referred to as a “ring family”. Illustratively, in FIG. 1, the following node sets (as well as others) form ring families: {11,12,13,14}, {11,14,15,16,17}, {13,20,19,14}, {14,19,18,15}, and {14,19,18,15,16}. The amount of traffic that each set of rings can carry (or the number of members in the family) is dependent, of course, on the number of information channels that are available in the logical links that comprise the ring family. The number of information channels that are assigned to a ring family A must be cognizant, of course, of the other ring families that share the logical links that make up the ring family. Specifically, the number of information channels in ring family A must be small enough so that—with respect to each logical link that is part of the ring of ring family A—the sum of the information channels that belong to other ring families, plus the number of information channels of ring family A does not exceed the number of information channels in the link. For example, the information channels on logical link 24-1 are shared among the first ring family, {11,12,13,14}, and the second ring family, {11 14,15,16,17} in the above mapping of the network. If the number of information channels in the link is 1000, the number of information channels on the first ring family is 200, and the number of information channels on the second ring family is 600, a third ring family can be defined that employs logical link 24-1, but the number of information channels that this ring family can have is not more than 200.

It should be noted that while the topological mapping of the network can create various ring families, the actual ring families that exist in the network are effected by the states of the switches within the nodes. Stated differently, different ring families can be provisioned by modifying the states of the switches within the network's nodes. It may also be noted that in order to satisfy a particular set of traffic demands, one does not need to explicitly identify or provision rings for the entire network, but only the rings that are needed to satisfy the traffic demand. Lastly, it may be noted that one might expect some ring arrangements to be better than others for a particular set of traffic demands. By “better” it is meant that some ring arrangements have a lower associated cost than the less good arrangements. The measure of cost is a designer's choice and does not form a part of this invention. For purposes of this disclosure, however, it is assumed that each logical link has an associated cost, and that the cost of a ring is related to the sum of the costs of the participating logical links and the number of nodes that are involved.

The network design and provisioning undertaking of this disclosure can be formulated as follows:

Given:

A network of nodes and logical links,

For each logical link, the set of physical links that are associated with it,

A number of information channels on each logical link that are already part of rings that are available to carry new traffic demands,

A number of information channels on each logical link that are idle and, therefore, can be configured into new rings.

The routing metric associated with each logical link,

A set of new demands that must be routed between specified pairs of end nodes.

A cost function that associates some cost with any given ring family.

Generate:

The set of all feasible candidate ring families.

Then choose:

A set of ring families to be provisioned,

The number of copies of each chosen ring family that are to be configured with available information channels,

An order in which demands should be routed over the network,

Such that:

The number of demands routed is maximized,

The “cost” of the provisioned rings is minimized,

The demands, considered in the indicated order, are routed according to the given “shortest path” metric, and

Each information channel over which demand is routed is part of some existing or newly configured ring.

FIG. 3 presents a general flow chart of a ring design process that is useful for provisioning an intelligent optical switching network; that is, a network where switches within the nodes can be provisioned (such as the node depicted in FIG. 2). Advantageously, the method is executed in a conventional computer that comprises conventional means to input information, conventional means for outputting the provisioning information that is applied to the various nodes in the FIG. 1 network.

In general, step 101 obtains data about the nodes of the network under consideration and the logical links that interconnect the nodes, as well as other input information as described in more detail below. Control then passes to step 102, where all feasible rings are generated for the presented network, and step 103 routes given traffic demands over the available information channels. Control then passes to step 104, where a least-cost set of rings is chosen to cover the information channels over which traffic demands have been routed, and control is passed to decision step 105. Step 105 determines whether there is potential for improvement. If so, control passes to step 106, where the logical link capacities are adjusted to modify the number of information channels that is considered available for being configured into rings, and control returns to step 103. When step 105 concludes that there is no potential for improvement, or that the number of attempted improvement iterations has reached a preselected limit, the process terminates.

As indicated above, step 101 accepts information about the network. Step 101 obtains information about the logical links of the network, and the end nodes where the logical links connect. This may be stored in the computer, indexed by pairs of nodes, where the indices run from 1 to M, where M is the number of nodes in the network. A location pointed to by indices j,k is non-empty if there exists a logical link between nodes j and k. A non-empty location contains an ID (e.g., a numeric index) of the logical link i that carries traffic between nodes j and k, the number of information channels (wᵢ) on logical link i that are idle and, therefore, able to be configured into rings, and the number of information channels on logical link i that are already part of rings and that are available to carry new traffic demands. In addition, for each logical link, there is a list of physical links that the logical link utilizes, and two metrics: a first that is employed in identifying the feasible rings, and a second that is employed in routing decisions. Since the first metric is typically related to the actual physical mileage of the link, for sake of convenience the follows refers to this measure as the “mileage” metric. The second measure, or metric, is referred to as the “routing” metric for the logical link. The routing metric is merely a measure that the network's administrator assigns to each logical link.

An array location having the numeric indexes 14,16 (indicating a logical link between nodes 14 and 16 in the FIG. 1 network) might, for example, contain the following information:

| | |
|---|---|
| Logical link ID: | 25 |
| Total number of idle information channels (w₁): | 50 |
| Total number of information channels that are part of existing | 30 |
| rings but available to carry new demands: | |
| Mileage metric: | 325.4 |
| Routing metric: | 250 |
| Physical links utilized: | |

Physical link between node 14 and 15,

Physical link between node 15 and 16.

Step 101 also accepts information about the additional traffic demands that the network needs to satisfy, advantageously expressed in terms of an array not unlike the array described above. Step 101 further accepts other costs, or thresholds, that the designer might wish to impose. To illustrate, as indicated above, the method disclosed herein limits itself to the use of only feasible rings, and that is the function of the step 102. Feasible rings, in the context of this disclosure, are those rings from the set of all rings that may be found in the network that satisfy a given set of engineering limitations, e.g., a maximum overall logical link “mileage” cost that is not greater than MAX_MILEAGE, and also a number of logical links that is not greater than MAX_HOPS. Thus, step 101 accepts the MAX_MILEAGE and MAX_HOPS parameters.

Lastly, step 101 prepares some data for the subsequent process steps. For example, to assist step 102, step 101 creates an edge dependency table, where the cell in the i^{th} row and the j^{th} column is 0 if edges i and j are physically independent of each other, and is 1 otherwise (when two logical links have a physical link in common, they are not independent of each other, because a fiber break extinguishes at least some information channels in both links). To further assist step 102, step 101 creates a shortest mileage distance matrix, where MIN_MILEAGE[A][Z] gives the length of the shortest mileage path from node A to node Z. This path consists of logical links and is based on the “mileage” cost for each logical link that is accepted as input, as described above. In addition, to further assist step 102, step 101 creates a shortest hop matrix, where MIN_HOP [A] [Z] gives the number of logical links on the “shortest hop” path from node A to node Z. A “shortest hop” path is the path with the fewest number of logical links.

To assist step 103, step 101 creates a Shortest-Path Route table, where the cell in the A^{th} row and the Z^{th} column gives a list of logical links, in sequence, that forms a path from node A to node Z, where this path is chosen to be the path that minimizes the sum of the “routing” metrics over all logical links in the path. It may be noted that there are many conventional methods for computing the shortest path between nodes A and Z, including the well-known Dijkstra's algorithm (E. W. Dijkstra, “A Note on Two Problems in Connection with Graphs,” Numerische Mathematik, Vol. 1, pp. 269-271 (1959))

Step 102 generates the set of all feasible rings that exist in the given network. This may be achieved by employing a graph cycles generation module that identifies the feasible cycles (rings) in the network, by sequentially considering each and every one of the network nodes as the root node (i.e., starting point) for possible cycles. It can be shown that the entire set of cycles of a network is covered when (a) each of the network nodes is considered as a root node for cycles, and (b) for each considered root node, the cycles that are included are the cycles where the root node has a lower numeric index than any of the other nodes in the cycle. This is accomplished for each considered node (root node), in turn, through a recursive process, whereby a module EXPLORE (PATH, M_BUGT, H_BUGT) is called, and it calls itself as a subprocess (as necessary). The variable PATH is initially set to the index of the considered (root) node, variable M_BUGT is initially set to the MAX_MILEAGE parameter, and variable H_BUGT is initially set to the MAX HOP parameter.

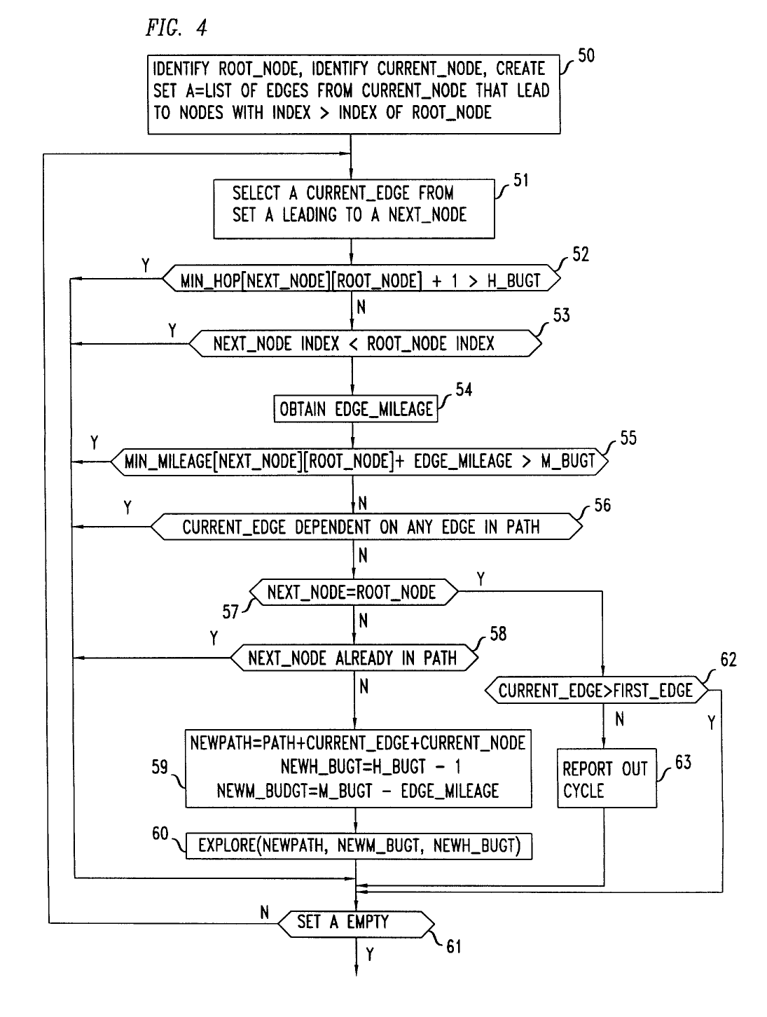

The EXPLORE process, depicted in FIG. 4, is node-centric, in the sense that it explores cycles from the last node specified in PATH. In step 50, the first node in PATH is identified as the ROOT_NODE, and the last node in PATH is identified as the CURRENT_NODE. A set A is then constructed to include all of the edges (i.e., indexes assigned to the edges) that lead away from the CURRENT_NODE, and control then passes to step 51, where an edge is selected (e.g., arbitrarily) from set A, assigned to variable CURRENT_EDGE, and deleted from set A. The variable NEXT_NODE is set to the index of the node at which the CURRENT_EDGE terminates. Control then passes to step 52, where it is determined whether completing the cycle by including the CURRENT_EDGE would exceed the H_BUGT variable (which in the initial execution of EXPLORE, for a given root node, is equal to the MAX_HOP limit). If so, control passes to step 61 where, if set A is not empty, control returns to step 51 to select another CURRENT_EDGE. If it is determined that completing the cycle by including the CURRENT_EDGE would not exceed the H_BUGT variable, control passes to step 53, where the index of the NEXT_NODE is compared to the index of the ROOT_NODE. If the NEXT_NODE index is lower than the ROOT_NODE index, then this node cannot belong to a cycle of the ROOT_NODE and, therefore, control passes to step 61, and the process continues as described above. Otherwise, control passes to step 54, where the mileage of the CURRENT_EDGE is obtained from a table installed by step 101 and assigned to variable EDGE_MILEAGE, and is followed by step 55, which determines whether completing the cycle by including the CURRENT_EDGE would exceed the M_BUGT variable (which in the initial execution of EXPLORE, for the given root node, is equal to the MAX_MILEAGE limit). If so, control passes to step 61 and the process continues as described above. Otherwise, control passes to step 56, where it is determined whether the CURRENT_EDGE is dependent on an edge that is already included in PATH. This information is obtained from the previously constructed dependency table, described above in connection with step 101. If the CURRENT_EDGE is dependent on an edge that is already in PATH, control passes to step 61 and the process continues as described above. Otherwise, control passes to step 57, where it is determined whether the NEXT_NODE is the ROOT_NODE. If so, it is concluded that a cycle has been identified for the ROOT_NODE, and control passes to step 62. Since whatever cycle is detected will be detected twice—once by leaving on edge E₁ and returning on edge E₂, and another time by leaving on edge E₂ and returning on edge E₁—one of these cycles needs to be discarded. Accordingly, step 62 accepts one of the cycles as a valid cycle, and rejects the other. In FIG. 4, the accepted cycle is one where the CURRENT EDGE (which is the edge by which the cycle returns to the ROOT_NODE) has a smaller index than the index of the first edge (obtained from the PATH variable). When a cycle is rejected, control passes to step 61 where the process continues as described above. When a cycle is accepted, control passes to step 63, which reports-out the cycle before passing control to step 61, for continuing the process as described above.

When the NEXT_NODE is not the ROOT_NODE, control passes from step 57 to step 58. In step 58, it is determined whether the index of the NEXT_NODE is already in PATH. If so, it means that a cycle has been formed that does not include the ROOT_NODE and, therefore, this CURRENT_EDGE is unacceptable. Accordingly, control passes to step 61, and the process continues as described above. If not, control passes to step 59, where PATH is extended to PATH+CURRENT_EDGE+NEXT_NODE. For example, if PATH was equal to (v11)(e21)(v12)—meaning node 11, logical link 21, and node 12—as control is received by step 59, the value of PATH is changed in step 59, for example, to (v11)(e21)(v12)(e22)(v13). Also, step 59 decrements the H_BUGT variable by 1, and decrements M_BUGT by the value of EDGE_MILEAGE.

At this point in the process, an edge and a node were added to the PATH variable of what is a possible cycle for the ROOT_NODE under consideration. Following the actions of step 59, control passes to step 60, where the EXPLORE process is called (i.e., a nested call) with the modified values for variables PATH, H_BUGT, and M_BUGT, to continue the cycles exploration by passing control to step 61. This iterative, nested, execution of the EXPLORE process results in all feasible cycles being identified.

The output of step 102 is two tables. The first is a table of cycles, or ring families, where each row specifies a ring family index number and the logical links that form the ring family. To this table can be appended the cost of an instance of the ring family, which is computed based on a chosen “ring” metric. This “ring cost” metric is a third metric that is used herein. It can be different from the “mileage” metric, and the “routing” metric and, for example, it can be, as mentioned above, some function of the “mileage” for the ring plus some cost that is related to the number of nodes in the ring. For example, an entry in the ring-families table might be:

| ring index, j | logical links | cⱼ - cost |
|---|---|---|
| 1 | 24, 25, 27, 26 | 120.2 |

The second table is an array with I rows (the number of logical links in the network) and J columns (the number of ring families found by step 102), where the cell at row i and column j, aᵢⱼ, contains the value 1 when ring family j contains logical link i, and 0 otherwise.

Returning to FIG. 3 and referring now to step 103, a demand is satisfied by establishing a route from the originating node to the terminating node. Such a route passes through a sequence of logical links, and more specifically, such a route is established by assigning to the route an available information channel in each of the logical links in the aforementioned sequence of logical links. Ideally, the route that is assigned to each demand is the “shortest-path” route, as determined by the “routing” metric. However, it is possible that the “shortest-path” route is unavailable, for example, when no unoccupied information channel exists in one of the logical links that participate in the “shortest-path” route. In such an event, the next-best available route is employed.

Step 103 determines the shortest-path of each demand from the Shortest-Path Route table, and then orders the demands by increasing length of the shortest paths (that is, we consider “short” routes first). For each demand, in order, starting with the demand having the “shortest” route, the step determines whether capacity still exists along the route specified in the shortest-path route. As suggested above, because of previously made assignments, capacity might not exist for the route specified in the shortest-path route. In such a case, step 103 takes the next-shortest-path route for the demand that is calculated (e.g., using Dijkstra's algorithm) by considering the “routing” metric for the remaining available capacity on links that can be used to establish a path between the originating node and the terminating node. If no route is found, the demand is marked as un-routed. When a route is decided upon, the information channels that this route will occupy are marked as no longer available; that is, in each logical link of the route, the number of unoccupied information channels of some ring family is decremented (the preferable action), or the number of unassigned information channels is decremented.

The first iteration of the demands-assignment process of step 103 terminates when all of the demands have been considered. If un-routed demands exist when the first iteration of the demands-assignment process is completed, the demands-assignment process may be repeated with a revised ordering of the demands; for example, by considering the un-routed demands first. The solution obtained from the second execution of the demands-assignment process is compared to the solution of the first execution of the demands-assignment process. The solution with the fewest un-routed demands is selected as the demands-assignment solution, and the associated ordering of the demands is selected as the ordering in which demands should be presented to the network. Such iterations can be repeated multiple times.

Once the routing of the demands has been determined in step 103, control passes to step 104, where a cost-efficient set of rings that cover as many of the demands as possible is chosen. Choosing the smallest-cost set of rings can be achieved by formulating an integer programming problem as follows:

$$\begin{matrix}M i n i m i z e {\sum }_{j = 1}^{J} {c}_{j} {x}_{j} + p {\sum }_{i = 1}^{I} {s}_{i} , & ( 1 ) \\ S u b j e c t t o {\sum }_{j = 1}^{J} {a}_{ij} {x}_{j} \leq {w}_{i} for each link i , \\ and & ( 2 ) \\ {\sum }_{j = 1}^{J} {a}_{ij} {x}_{j} + {s}_{i} \geq {d}_{i} for each link i . & ( 3 )\end{matrix}$$

where

cⱼ=“cost” of a ring in candidate ring family j,—obtained from the first table resulting from step 102,

dᵢ=number of units of demand routed on logical link i, minus the number of available information channels that are already part of rings and thus can carry demands routed on i—obtained from the results of step 103; this, then represents the number of units of demand that must be carried by newly-provisioned rings,

aᵢⱼ=1 if ring of family j employs link i; 0 otherwise,—obtained from the second table resulting from step 102,

p=penalty for not covering a unit of demand on a logical link,—one of the parameters supplied by the user to step 101,

wᵢ=the number of available idle information channels on link i,—obtained from step 101,

xⱼ=the number of copies of ring family j to include in the solution,—one set of unknowns that the solution of the integer programming problem supplies, and

sᵢ=the number of demands not covered on logical link i,—another set of unknowns that the solution of the integer programming problem supplies.

The first term of equation (1) represents the cost of a copy of ring family j, (cⱼ), multiplied by the number of copies, xⱼ, of ring family j that the solution of the integer programming problem suggests, summed over all ring families in the network. The second term represents the cost of failing to satisfy a demand, and it consists of the sum, over all links i, of the cost of failing to satisfy one demand on link i multiplied by the number of demands not satisfied. Thus, equation (1) represents the overall cost of the topology suggested by the solution of the integer programming problem. Heuristically one can observe that the cost measure of equation (1) is lowered when the number of uncovered demands (demands that are not routed through rings) is small, or 0,—which is clearly one of the desired results—, and when the first term of equation (1) has only few non-zero terms, and those non-zero terms are associated with rings that have low costs.

Equation (2) says that, in each logical link, the sum of all copies of ring families that utilize the logical link must be not greater than the number of available idle information channels in the link.

Equation (3) says that, in each link, the sum, over all ring families, of copies of rings that utilize logical link i plus the number of demands that are not covered by the solution, must be at least equal to dᵢ, the number of units of demand routed on logical link i. This constraint forces the number of ring families that are used in the solution of the integer programming problem to be large enough, so as to meet the need to provide the d, information channels in all of the links, i.

This ILP problem can be solved by any of the commercially available packages, such as the CPLEX Mathematical Programming Package from Ilog Corporation. Since this is an integer program, it may not be possible to find the optimal solution within a reasonable computation time. However, it was found that on all the test problems that were run, it was possible to find a very good solution quite quickly (and which is provably within a small percentage of the optimal solution). Thus, it was found that imposing a reasonable limit on the amount of computation time used for obtaining a solution does not present a problem, because the developed solutions—though perhaps not optimal—are fairly good. The capability to impose a limit on the computation time employed is normally available in such commercially available packages.

The result of step 104 provides the optimum, or close to the optimum, solution for which of the feasible ring families identified in step 102 should be employed and how many members of each ring family should be provisioned. Still, that solution may have two negative attributes: unsatisfied demands (which don't even go into the ILP formulation) and uncovered demands (which don't have the protection offered by the ring architecture). Another, inchoate, negative attribute exists when the loads on the logical links of one or more rings are unbalanced. To illustrate the notion of balance, consider, for example, a situation where we have provisioned N members in the ring family that comprises nodes 11, 14, 16, and 17. However, an examination of the information channels that are actually being used reveals that the N information channels on logical link 27 and logical link 26 are fully utilized, whereas the N information channels on logical link 24 and logical link 25 are not being used at all. If N is greater than 1, the usage of the ring family is considered unbalanced since it may be possible to reroute remands away from links 26 and 27 and to links 24 and 25, and then cover the routed demands with fewer than N copies of the ring family.

A different solution can be forced in step 103 by forcing a re-routing of some of the demands on logical links 27 and 26, and this can be achieved by assuming that there are fewer idle information channels in those logical links (i.e., in the overloaded links) than there actually are. This would force a re-routing of some of the demands utilizing logical links 27 and 26, leading to a different (and potentially more balanced and efficient) set of rings.

Hence, following step 104, control passes to step 105 which determines whether there are

unsatisfied demands,

satisfied demands not covered by rings, or

loads in the logical links of one or more rings that are significantly unbalanced (e.g. most links are 60% loaded but one ring is 99% loaded). When any of these conditions is found to exist, control passes to step 106, where the available capacity of one or more links is adjusted, and control returns to step 103. This may be repeated, if necessary, any number of times.

Finally, when a solution is accepted from step 105, the switches within the nodes of the network, such as the nodes of the FIG. 1 network, are provisioned in a conventional way. This can include an automated system whereby the computer that creates the assignments communicates directly with the switches and transmits to them the appropriate information, or a system that includes some human interactions.

The above disclosed the principles of the invention, but it should be appreciated that various changes, modifications, and enhancements are possible to be incorporated without departing from the spirit and scope of the invention.

1. A method carried out in a computer for provisioning rings in a ring-based network having a given topology of nodes and logical links that interconnect said nodes, and a set of traffic demands that is desired for said network to carry, comprising the steps of:
executing a process that identifies a set of feasible rings in said network, which is a subset of all possible rings in said network that satisfy a given constraint;
executing a process of identifying a routing for the traffic demands in said set of traffic demands, while aiming to minimize both a number of traffic demands that are not routed and an overall routing metric, where the routing metric is a cost measure that is associated with using one of said logical links in a routing path of a demand;
identifying a set of rings from among a set of feasible rings that minimizes a ring assignments cost measure that includes a cost associated with not covering routed demands with rings and a cost associated with using rings to cover demands; and
outputting the set of rings developed by said step of identifying for provisioning said nodes of said network.

2. The method of claim 2 where said constraint requires a feasible ring to have not more than a given number of nodes, and have a mileage cost that is not more than a given mileage cost.

3. The method of claim 1 further comprising the step of provisioning said nodes of said network in accordance with said set of rings developed by said step of identifying.

4. The method of claim 3 where said provisioning is accomplished through electronic transmission of information from said computer to said nodes of said network.

5. The method of claim 1 where said process of identifying a routing for the traffic demands
(a) considers a routing path for each of said demands, starting with the demand having a lowest routing path cost, based on a table that identifies a path having a lowest routing path cost for each arbitrary pair of nodes of said network;
(b) assigns a demand to said path having said lowest routing path cost, if capacity exists on said path having said lowest routing path cost;
(c) assigns said demand to a path having a higher routing path cost if capacity does not exist on said path having said lowest routing path cost; and
(d) leaves said demand un-routed if capacity does not exist on any path that can carry said demand, thereby obtaining an identified routing of said demands.

6. The method of claim 1 where said process of identifying a routing for the traffic demands employs a shortest routing path metric

7. The method of claim 1 where said process of identifying a routing for the traffic demands identifies a set of demand routings A by:
(a) considering a routing path for each of said demands, starting with the demand having a lowest routing path cost, based on a table that identifies a path having a lowest routing path cost for each arbitrary pair of nodes of said network;
(b) assigning a demand to said path having said lowest routing path cost, if capacity exists on said path having said lowest routing path cost;
(c) assigning said demand to a path having a higher routing path cost if capacity does not exist on said path having said lowest routing path cost;
(d) leaving said demand un-routed if capacity does not exist on any path that can carry said demand, thereby obtaining a first identified routing of said demands, B;
(e) changing order in which said demands are considered and repeating steps (b), (c), and (d) to result in a second identified routing of said demands, C; and
(f) assigning A=B when number of un-routed demands in B is less than number of un-routed demands in C, and A=C when number of un-routed demands in B is not less than number of un-routed demands in C.

8. The method of claim 7 where said table is pre-computed.

9. The method of claim 1 where said step of identifying a set of rings employs an integer linear programming module to obtain said set of rings that minimizes said ring assignments cost function.

10. The method of claim 1 where said ring assignments cost function is
$${\sum }_{j = 1}^{J} {c}_{j} {x}_{j} + p {\sum }_{i = 1}^{I} {s}_{i} ,$$
that is minimized subject to
$${\sum }_{j = 1}^{J} {a}_{ij} {x}_{j} \leq {w}_{i}$$
for each link i, and
$${\sum }_{j = 1}^{J} {a}_{ij} {x}_{i} + {s}_{i} \geq {d}_{i}$$
for each link i, where
cⱼ=“cost” of a ring in candidate ring family j,
dᵢ=number of units of demand routed on logical link i of said network, minus the number of available information channels that are already part of,
aᵢⱼ=1 if ring of family j employs link i; 0 otherwise,
p=penalty for not covering a unit of demand on a logical link,—one of the parameters supplied by the user to step 101,
wᵢ=number of available idle information channels on link i,
xⱼ=number of copies of ring family j to include in the solution, and
sᵢ=number of demands not covered on logical link i.
